(19) United States
(12) Patent Application Publication
(10) Pub. No.: US 2025/0077792 A1
(43) Pub. Date: Mar. 6, 2025

(54) FINE-TUNING LARGE LANGUAGE MODELS FOR DOMAIN-SPECIFIC ENVIRONMENTS

(71) Applicant: Microsoft Technology Licensing, LLC, Redmond, WA (US)

(72) Inventors: Xilun Chen, Sunnyvale, CA (US); Tzu Ming Kuo, Jersey City, NJ (US); Xiaoqiang Luo, Cos Cob, CT (US); Ilya Dan Melamed, New York, NY (US); Ji Yan, San Jose, CA (US); Peide Zhong, San Jose, CA (US)

(21) Appl. No.: 18/459,290

(22) Filed: Aug. 31, 2023

(51) Int. Cl. G06F 40/40; G06N 20/20

(52) U.S. Cl. CPC G06F 40/40; G06N 20/20

(57) ABSTRACT

Embodiments of the disclosed technologies are capable of a training pipeline to fine-tune a machine learning model given a limited set of domain-specific data. The embodiments describe using a first machine learning model to generate a pseudo label associated with a domain-specific training document. The pseudo label comprises a machine-generated text of a content type extracted from the domain-specific training document. The embodiments further describe fine-tuning a second machine learning model using the pseudo label, the domain-specific training document, a first low-rank weight matrix, and a second low-rank weight matrix. The fine-tuned second machine learning model generates text of the content type from a domain-specific document.

### TECHNICAL FIELD

Embodiments of the invention relate to the field of fine-tuning machine learning models; and more specifically, to fine-tuning large language models.

### BACKGROUND ART

Large language models can include billions of hyperparameters that allow large language models to perform natural language processing tasks. Training large language models requires significant computing resources and training data.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for training one or more machine learning models using a training manager component of a computing system, in accordance with some embodiments of the present disclosure.

FIG. 2 is a flow diagram of an example method for training a training data generator, in accordance with some embodiments of the present disclosure.

FIG. 3 illustrates an example architecture of a neural network, in accordance with some embodiments of the present disclosure.

FIG. 4 is a flow diagram of an example method for fine-tuning a pretrained machine leaning model using supervised learning, in accordance with some embodiments of the present disclosure.

FIG. 5 is a flow diagram of an example method of deploying multiple adaptation components in a fine-tuned machine learning model, in accordance with some embodiments of the present disclosure.

FIG. 6 is a flow diagram of an example method for deploying a fine-tuned machine learning model, in accordance with some embodiments of the present disclosure.

FIG. 7 is a block diagram of a computing system that includes a training manager component, in accordance with some embodiments of the present disclosure.

FIG. 8 is a flow diagram of an example method for fine-tuning a machine learning model, in accordance with some embodiments of the present disclosure.

FIG. 9 is a block diagram of an example computer system including a training manager component, in accordance with some embodiments of the present disclosure.

### DETAILED DESCRIPTION

A generative model uses artificial intelligence technology, e.g., neural networks, to machine-generate new digital content based on model inputs and the previously existing data with which the model has been trained. Whereas discriminative models are based on conditional probabilities P(y|x), that is, the probability of an output y given an input x (e.g., is this a photo of a dog?), generative models capture joint probabilities P(x, y), that is, the likelihood of x and y occurring together (e.g., given this photo of a dog and an unknown person, what is the likelihood that the person is the dog's owner, Sam?).

A generative language model is a particular type of generative model that generates new text in response to model input. The model input includes a task description, also referred to as a prompt. The task description can include instructions and/or examples of digital content. A task description can be in the form of natural language text, such as a question or a statement, and can include non-text forms of content, such as digital imagery and/or digital audio.

A large language model (LLM) is a type of generative language model that is trained using an abundance of domain-neutral data (e.g., publicly available data) such that billions of hyperparameters that define the LLM are used to learn a domain-neutral task. Some pre-trained LLMs, such as generative pre-trained transformers (GPT) can be trained to perform tasks including natural language processing (NLP) tasks such as text extraction, text translation (e.g., from one language to another), text summarization, and text classification.

LLMs are trained to perform tasks by relying on patterns and inferences learned from training data, without requiring explicit instructions to perform the tasks. Supervised learning is a method of training a machine learning model, such as an LLM, given input-output pairs. An input-output pair is an input with an associated known output (e.g., an expected output, a labeled output, a ground truth).

During a training period, a machine learning model learns to perform a task, such as an NLP task, by receiving training samples included as a training input. The machine learning model then predicts an output related to the task to be learned and compares the predicted output to the known output associated with the training input (e.g., the output of the input-output pair). Over time, (e.g., a number of training iterations), an error based on the difference between the predicted output and the known output decreases. To train the machine learning model to perform the target task, large amounts of training samples (including training inputs and associated known outputs) are used to train the machine learning model. Collecting such training samples can be time consuming, costly, and error prone. For example, in some conventional approaches, hundreds of thousands of training samples (e.g., input-output pairs) are used to train the machine learning model.

One example LLM is a bidirectional encoder representation for transformers (BERT) machine learning model. BERT is a machine learning model used to perform NLP tasks. A BERT model is well suited for NLP tasks because BERT learns a contextual relationship of words (or characters, phrases) in one or more sentences. BERT tokenizes portions of words and subsequently predicts a label associated with the token to extract, classify, and/or detect tokens of the sentence. One example of an NLP task that can be learned by a BERT model is Named Entity Recognition (NER) in which tokens of a text are identified and categorized into predetermined categories. Accordingly, a BERT model can classify or identify text by categorizing the tokens of words of the text into predetermined categories.

While pretrained machine learning models may be well suited to perform various domain-neutral tasks (e.g., tasks learned using widely available or public data), applying domain-specific data to such machine learning models can cause a drop of the machine learning model's performance. For example, a machine learning model is less suited to perform text summarization of a domain-specific text if the machine learning model has not been trained to summarize text using domain-specific language.

Fine-tuning a pre-trained machine learning model as used herein may refer to a mechanism of adjusting the hyperparameters of the machine learning model that has been pre-trained on domain-neutral data, and then tuning the pre-trained machine learning model to perform a similar task in a domain-specific environment. For example, a machine learning model trained to perform text summarization using domain-neutral data can be fine-tuned to perform domain-specific text summarization using domain-specific data.

Machine learning models which are suited to perform domain-neutral tasks may become overparameterized given the domain-specific environment. An overparameterized machine learning model is a machine learning model designed with more neurons, weights, layers, or other hyperparameters than necessary to perform the domain-specific task. Accordingly, various neurons, layers, weights, or other hyperparameters become redundant or otherwise unnecessary when performing the domain-specific task. The technologies described herein leverage redundant neurons to determine a low intrinsic dimension of weights used to learn domain-specific tasks. In this manner, the training time associated with training the machine learning model to learn domain-specific tasks is reduced. Additionally, the training data associated with fine-tuning the machine learning model to learn the domain-specific tasks is reduced.

In some conventional systems, multiple machine learning models are each trained to perform a different domain-specific task. For example, in some conventional systems, a first machine learning model is trained to extract a first content type from content items. For instance, the conventional first machine learning model extracts job titles of users from resumes, articles, and job postings. In the same example, a second machine learning model is trained to extract a second content type from content items. For example, the conventional second machine learning model extracts user skills from resumes, articles, and job postings. Embodiments of the technologies described herein can avoid the need to deploy multiple separately trained models by leveraging adaptation components that mimic multi-task learning to perform multiple domain-specific tasks. In this manner, computing resources associated with deploying multiple machine learning models is reduced. For example, instead of deploying two machine learning models, as in the above-described example of a conventional system, embodiments deploy a single machine learning model with two adaptation components.

The technologies described herein are capable of generating training data (including training inputs and associated outputs) to fine-tune a pretrained machine learning model (which may be referred to herein as a base machine learning model or a pretrained machine learning model) using limited domain-specific data. The pretrained machine learning model is fine-tuned to perform domain-specific tasks using two to three orders of magnitude fewer hyperparameters than the hyperparameters trained in the pretrained machine learning model. Because fewer hyperparameters of the pretrained machine learning model are fine-tuned, the amount of training data can also be reduced by two or three orders of magnitude. For example, one hundred domain-specific training samples (input-output pairs) can fine-tune a pretrained machine learning model to perform a domain-specific task. Reducing the number of fine-tuned hyperparameters reduces the time it takes to fine-tune the pretrained machine learning model, which conserves computing resources such as power and memory.

Embodiments of the technologies described herein include a two-stage training pipeline used to fine-tune a pretrained machine leaning model to a domain-specific environment. In the first stage of the training pipeline, a first machine learning model is trained to generate domain-specific training data, reducing the time, cost, and human error associated with manually determining input-output pairs. The first machine learning model is provided a small set of training data and generates supplemental training data.

In the second stage of the training pipeline, a second machine learning model is fine-tuned to perform one or more domain-specific tasks using the generated supplemental training data. In some embodiments, adaptation components are trained to perform a domain-specific task using a parameter efficient low rank representation of the pretrained weights of the pretrained machine learning model.

The technologies described herein perform a text extraction task by generating text using an LLM. In this manner, the LLM described herein extracts text by performing a text generation task instead of a sequence tagging task. For example, an LLM is trained to generate a text classification for a token, as opposed to labeling a token according to a set of predetermined classes.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

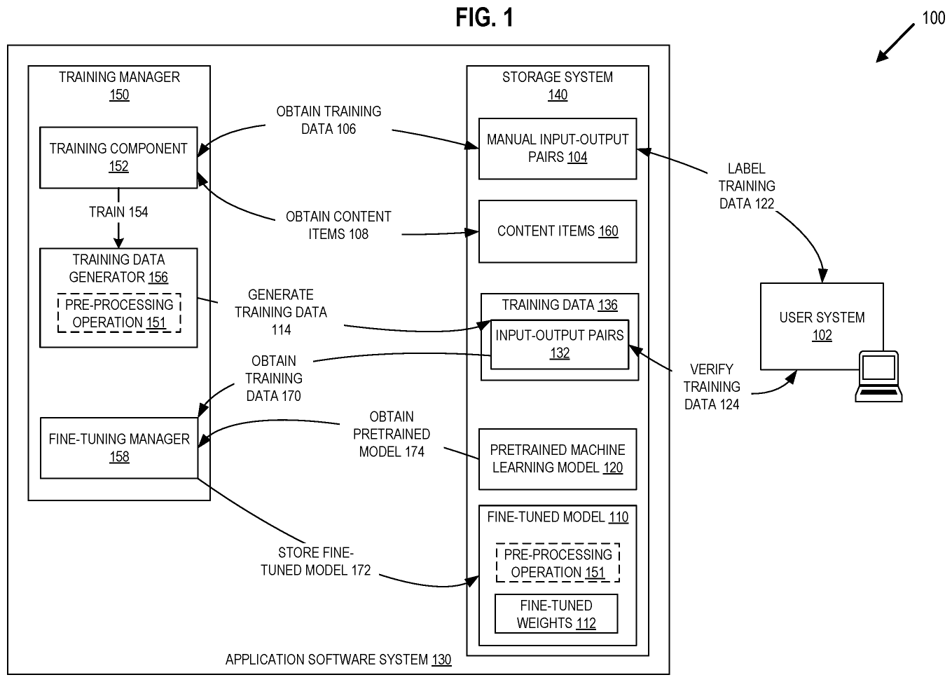

FIG. 1 is a flow diagram of an example method for training one or more machine learning models using a training manager component of a computing system, in accordance with some embodiments of the present disclosure.

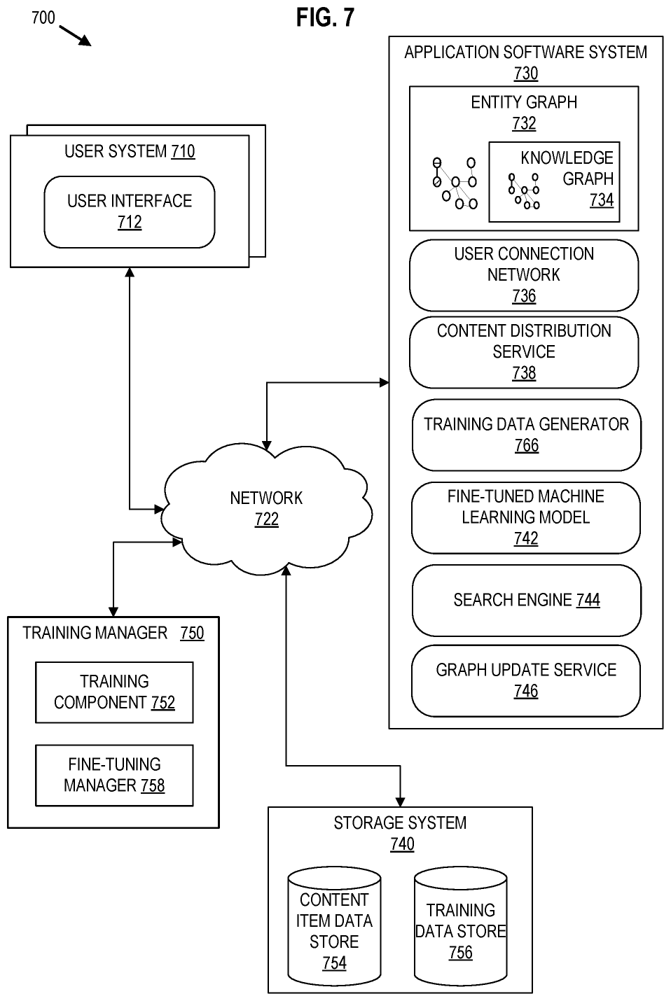

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of the training manager 150, including, in some embodiments, components shown in FIG. 1 that may not be specifically shown in FIG. 7, or by the training manager 750 of FIG. 7, including, in some embodiments, components shown in FIG. 7 that may not be specifically shown in FIG. 1, or by components shown in any of the figures that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, in the example computing system 100, an example application software system 130 is shown, which includes a training manager 150 and a storage system 140. The training manager 150 of FIG. 1 includes a training component 152, a training data generator 156, and a fine-tuning manager 158 as described with reference to FIG. 7. In the example of FIG. 1, the components of the application software system 130 are implemented using an application server or server cluster. For example, the training component 152, training data generator 156, and fine-tuning manager 158 are each hosted or otherwise executed using the training manager 150. In yet other implementations, the components of the training manager 150 are executed as an application or service, executed remotely or locally.

As described in more detail below, training manager 150 includes a training component 152 to train the training data generator 156 to generate training data 136 including input-output pairs 132. The training manager 150 also includes the fine-tuning manager 158 to fine-tune a pretrained machine learning model 120 to obtain the fine-tuned model 110 using the input-output pairs 132 determined, at least in part, by the training data generator 156.

As shown, the storage system 140 stores training data generated by the training data generator 156 (e.g., input-output pairs 132 of the training data 136), manually determined training data (e.g., manual input-output pairs 104), digital content items 160, one or more pretrained machine learning models 120, and/or fine-tuned models 110.

In some embodiments, storage system 140 stores manually labeled input-output pairs 104. Manually labeled input-output pairs 104 include inputs with corresponding outputs. Each of the manual input-output pairs 104 are related to a task to be learned by the fine-tuned model 110. For example, an input could be a domain-specific document (e.g., a resume) and the output could be a first type of content extracted from the domain-specific document (e.g., a most recent work experience listed in the resume). Alternatively, the input could be a domain-specific document (e.g., a job description) and the output could be a second type of content extracted from the domain-specific document (e.g., a skill associated with the job description). The manually labeled input-output pairs 104 may be labeled during label training data 122 by one or more users using user system 102 such as administrators, engineers, or other personnel.

In some embodiments, the storage system 140 includes content items 160. Content items 160 can include any digital content items such as job postings, comments, resumes, and articles. In some embodiments, content items 160 include unstructured data. Unstructured data includes files stored without metadata or a predetermined format. For example, unstructured data may include data in any format and/or data in a predetermined structure, in contrast to structured data that is formatted according to a predetermined format. Examples of unstructured data include text documents, audio files, video files, analog sensor data, images, and/or other unstructured text files in which the data contained within each file lacks a predefined structure. For example, content of a resume content item 160 can be structured (e.g., using bullet points, headers, spacing, etc.). In contrast, content of comment content item 160 can be less structured (e.g., free style).

In some embodiments, the storage system 140 includes training data 136 such as input-output pairs 132 determined, at least in part, by the training data generator 156, as described herein. In some embodiments, one or more users of the user system 102 (such as administrators, engineers, or other personnel) can verify training data 136 during verify training data 124. For example, one or more users of the user system 102 can read an input and verify that the determined output associated with the input is accurate. For instance, if the input is a resume and the output is supposed to be extracted text pertaining to the contact information included in the resume, a user using the user system 102 verifies that the extracted text is the contact information included in the resume. In some embodiments, the user can add training data 136 by manually adding input-output pairs (such as the manual input-output pairs 104).

In some embodiments, the storage system 140 includes a pretrained machine learning model 120. The pretrained machine learning model may be a machine learning model that has been pretrained using domain-neutral data. As described herein, the pretrained machine learning model 120 is fine-tuned to obtain the fine-tuned model 110. The fine-tuned model 110 includes fine-tuned weights 112 that allow the fine-tuned model 110 to learn the relationships of domain-specific data (in addition to, or instead of, the relationships of the domain-neutral data). As described herein, the fine-tuned weights 112 can include a defined first low-rank weight matrix and a defined second low-rank weight matrix. In some embodiments, the storage system 140 stores the fine-tuned model 110.

In other embodiments, the storage system 140 stores the fine-tuned weights 112 of the fine-tuned model 110 (e.g., the defined first low-rank weight matrix and the defined second low-rank weight matrix). In these embodiments, to deploy the fine-tuned model 110, the pretrained machine learning model 120 is deployed in addition to the fine-tuned weights 112 learned from fine-tuning the fine-tuned model 110. Accordingly, the fine-tuned weights 112 can be deployed with the pretrained machine learning model 120 using an adaptation component including the defined set of low-rank matrices. In this manner, the pretrained machine leaning model 120 uses the fine-tuned weights 112 to model the relationships learned during fine-tuning using the domain-specific data.

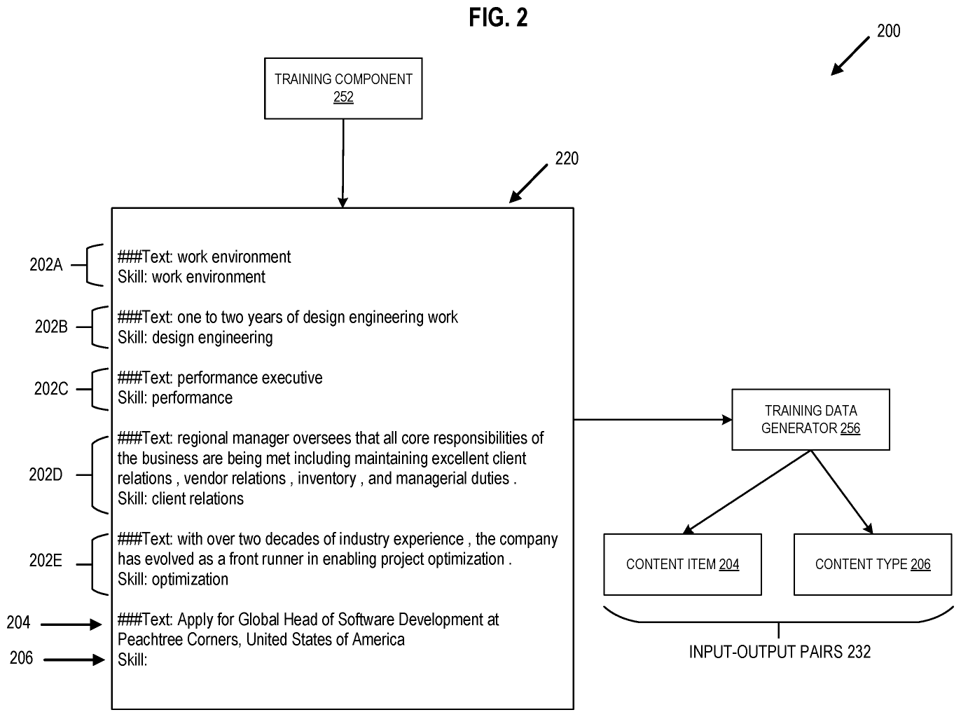

As shown in the example of FIG. 1, in operation, the training component 152 obtains training data 106 by querying the storage system 140, and receiving, from the storage system 140, manual input-output pairs 104. The training component 152 uses the manual input-output pairs 104 to train 154 the training data generator 156. Additionally, the training component 152 obtains content items 108 by querying the storage system 140, and receiving, from the storage system 140, content items 160. In some embodiments, before content items 160 are used to generate training data, user permission is obtained. For example, an author of a content item 160 consents to using content item 160 as training data. Each stored content item in content items 160 is considered an input without a corresponding labeled output. The manual input-output pairs 104 and content items 160 are sampled such that the training component 152 trains the training data generator 156 to generate outputs associated with the content item 160. Training the training data generator 156 to generate outputs associated with the content items 160 (e.g., pseudo label the content items) is described in more detail with reference to FIG. 2. The training data generator 156 labels the content items 160, generating input-output pairs. In some embodiments, the training data generator 156 trained by the training component 152 is an LLM. For example, the training data generator 156 may be a generative pre-trained transformer (GPT).

As described herein, manually generating input-output pairs 104 is costly, time-consuming, and error prone. Accordingly, the number of manual input-output pairs 104 used to train the training data generator 156 is limited. The training data generator 156 expands or otherwise supplements the limited set of training data (e.g., manual input-output pairs 104) by pseudo labeling outputs. In this manner, the training data generator 156 learns to generates training data 136 including input-output pairs 132, where the input is an unlabeled content item of the content items 160, and the output is a pseudo label output associated with a particular task. The generated training data 114 is passed to the storage system 140 for storage as training data 136.

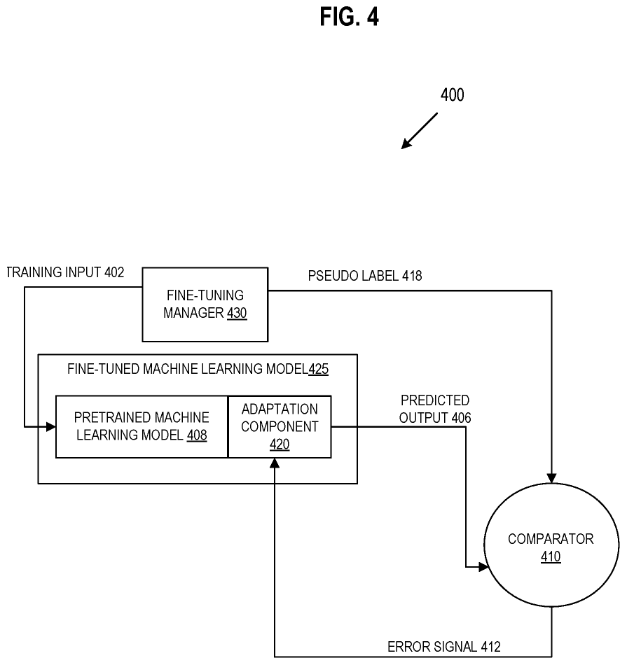

The fine-tuning manager 158 obtains training data 170 by querying the storage system 140 for input-output pairs 136, and receiving, from the storage system 140, the training data 136 including input-output pairs 132. The fine-tuning manager 158 also obtains pretrained model 174 by querying the storage system 140 for the pretrained machine learning model 120, and receiving, from the storage system 140, the pretrained machine learning model 120. Fine-tuning the pretrained machine learning model 120 using the fine-tuning manager 158 is described with reference to FIG. 4. In some embodiments, the pretrained machine learning model 120 is an LLM. As a result of fine-tuning the pretrained machine learning model 120 using the input-output pairs 132, the pretrained machine learning model 120 becomes the fine-tuned model 110. The fine-tuned model 172 (and/or the fine-tuned weights 112 that differentiate the fine-tuned model 110 from the pretrained machine learning model 120) is passed to the storage system 140 for storage as fine-tuned model 110 and/or fine-tuned weights 112. In some embodiments, the training component 152 performs the operations of the fine-tuning manager 158.

The pre-processing operation 151 is optionally included in the training data generator 156 and/or the fine-tuned model 110. The pre-processing operation 151 prepares prompts for the training data generator 156 based on the input. For example, the pre-processing operation 151 transforms content items 160 into a prompt that the training data generator 156 can subsequently complete. In some embodiments, the pre-processing operation 151 constructs prompts to query the training data generator 156 to generate pseudo labels. For example, the pre-processing operation 151 selects different prompt templates to generate training data learned for different tasks (e.g., content extraction tasks). In some embodiments, the mapping of a prompt template to a task is predetermined. For example, a resume content item can be mapped to a prompt, an article can be mapped to a prompt, etc. The pre-processing operation 151 can include one or more classifiers to classify the content item (e.g., a resume, an article, a comment) and select the corresponding predetermined mapped prompt template based on the classification of the content item. In some embodiments, the mapping of the prompt template to the task is dynamically determined. For example, one or more language models can generate a prompt template using the content item.

The examples shown in FIG. 1 and the accompanying description above are provided for illustration purposes. This disclosure is not limited to the described examples. Additional or alternative details and implementations are described herein.

FIG. 2 is a flow diagram of an example method for training a training data generator, in accordance with some embodiments of the present disclosure.

In operation, the training component 252 uses semi-supervised learning to train the training data generator 256 to generate pseudo labels using the manual input-output pairs 104 and content items 160, as described with reference to FIG. 1.

As described herein, LLMs receive a prompt input, which includes a description of the task to be performed by the LLM. In some instances, the prompt is the natural language instruction of the LLM. As described with reference to FIG. 1, the training component 252 obtains manual input-output pairs. As shown in FIG. 2, five manually labeled input-output pairs are illustrated as 202A-202E and included in prompt 220. For example, manually labeled input-output pairs can be randomly sampled from the obtained manually labeled input-output pairs and included as part of prompt 220. In example 200, the content item 204 in prompt 220 indicates the task to be learned by the training data generator 256. That is, the training data generator 256 learns to generate text (e.g., the skill category 206) as a pseudo label associated with the content item 204. As shown, the content item 204 is a sentence which may have been randomly selected from content item 160 of FIG. 1. For example, content item 160 of FIG. 1 may be an article of a job description (e.g., a domain-specific document), and content item 204 is a sentence randomly sampled from content item 160 of FIG. 1.

As described herein, in some embodiments, unlike systems that tag tokens of text and classify such tagged tokens as belonging to a predetermined category (e.g., NER tasks), the training component 252 trains the training data generator 256 to generate text as a pseudo label that can be used as the content type 206 (e.g., a skill) associated with the content item 204.

The training component 252 provides prompts including manual input-output pairs and unlabeled content items to the training data generator 256 such that the training data generator 256 learns to create a pseudo label (e.g., an output such as content type 206) associated with an input (e.g., content item 204). Any one or more prompt engineering techniques may be used by the training component 252 to determine the prompt to be provided to the training data generator 256. The prompt 220 of example 200 illustrates an example of a few-shot prompt at a phrase level. That is, in addition to a task description (e.g., the content item 204 to be labeled by the training data generator 256), the prompt 220 several examples such as manually labeled input-output pairs 202A-202E.

As a result of the semi-supervised training performed by the training component 252, the training data generator 256 learns to determine pseudo labels (which also may be referred to herein as weak labels) as input-output pairs 232. In this manner, the training data generator 256 is able to supplement manually labeled input-output pairs with generated input-output pairs. In some embodiments, the generated input-output pairs reduce the need for manually labeled input-output pairs, thereby conserving computing resources associated with manually labeling input-output pairs and time spent manually labeling input-output pairs.

While the prompt 220 of example 200 illustrates a few shot prompt at the phrase level (e.g., the manually labeled output is one or two words associated with a phrase or other portion of an input sentence), other prompts at other granularities can be generated by the training component 252. For example, the training component 252 may generate zero shot prompts that do not include any examples of input-output pairs, the training component 252 may generate sentence-level prompts (e.g., a sentence extracted from a resume, article, job posting, or other content item is associated with a manually labeled output), and the training component 252 may generate document-level prompts (e.g., a resume, job posting, article, or other content item is associated with a manually labeled output). For example, given a sentence-level prompt, the pseudo labels (e.g., the text generation output by the training data generator 256 associated with the sentence-level input) may be more rich or descriptive than the pseudo labels determined by the phrase-level prompt 220 of example 200.

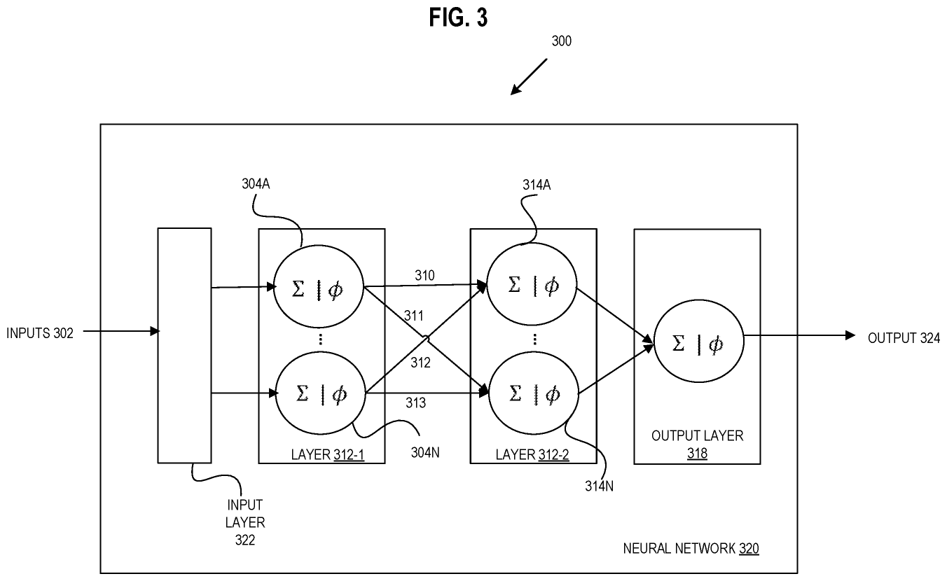

FIG. 3 illustrates an example architecture of a neural network, in accordance with some embodiments of the present disclosure.

As described herein, a neural network is one example of a machine learning model. The example 300 illustrates a fully connected architecture of a neural network 320. As illustrated, the neural network 320 includes a stack of distinct layers (vertically oriented) that receive an input 302 between an input layer 322 and an output layer 318. The input layer 320 can perform some processing of the input 302 such as padding the input 302 and/or normalizing the input 302. The output layer 318 receives an input from each of the nodes of the adjacent layer 312-2 to determine an output 324.

A stack of layers allows the neural network 320 to perform sub-tasks associated with learning a particular task. For example, a stack of layers in the neural network 320 may perform an encoding sub-task, a pooling sub-task, a decoding sub-task, and an attention sub-task. The sub-tasks of the neural network 320 transform the input 302 into a latent space representation in which unobserved features are determined such that the relationship and other dependencies of such features can be learned. The stack of layers includes neurons (illustrated as nodes E04A-304N and 314A-314N) and weights (e.g., weights 310-313). The weights interconnecting the neurons can be visually represented as the weights 310-313.

In the neural network 320, the first layer 312-1 has nodes 304A-304N, and the second layer 312-2 has nodes 314A-314N. The nodes 304A-304N and 314A-314N perform a particular computation and are interconnected to the nodes of adjacent layers. For example, node 304A in layer 312-1 is connected to nodes 314A-314N and node 304N in layer 312-1 is connected to nodes 314A-314N. For simplicity, other nodes and other connections are not shown. Each of the nodes 304A-304N and 314A-314N sum up the values from the adjacent nodes and apply an activation function, allowing the neural network 320 to detect nonlinear patterns in input 302.

Each of the nodes 304A-304N and 314A-314N are interconnected by weights 310-313. The weights 310-313 modify the effect of the connected nodes. For example, the node 304A applies an activation function to the input 302 to modify the input. The modified input is passed to the node 314A via weight 310. The value of the weight affects how the node 314A in layer 312-2 receives the output of node 304A in layer 31202. The values of the weights are tuned during training.

When supervised learning is used to train the neural network 320, the values of the weights are tuned based on an error (e.g., determined by comparing the output 324 to a known output). For example, the neural network 320 can be trained using backpropagation. The backpropagation algorithm operates by propagating the error through the neural network 320. The error may be calculated each training iteration (e.g., each input-output pair, as described with reference to FIG. 4), batch, and/or epoch and propagated through all of the weights in one or more stacks of layers in the neural network 320 such that the value of the weights adapt based on the amount of error. In some embodiments, the weights are updated by the steepest descent method. Mathematically, for each iteration of training n, the weights are updated according to Equation (1) below:

$${w}_{j i} ( n + 1 ) = {w}_{j i} ( n ) + Δ {w}_{j i} \qquad ( 1 )$$

In Equation (1) above, wⱼᵢ represents the weight that connects neuron i to neuron j. For example, wⱼᵢ can represent weight 310 that connects neuron 314A to neuron 304A. The steepest descent method is an optimization technique that minimizes a loss function. In other words, the steepest descent method is able to adjust unknown parameters (e.g., the value of each weight) in the direction of steepest descent. During training, the value of the weights that optimize the accuracy of the output 324 is unknown.

Depending on the location of the neuron in the network, a different formula is used to determine how the weights are adjusted with respect to the loss function ε(n). Mathematically, this is represented according to Equation (2) below:

$$Δ {w}_{j i} = - \frac{\partial ε ( n )}{\partial {w}_{j i ( n )}} \qquad ( 2 )$$

During each training iteration, the weights are tuned to reduce the amount of error thereby minimizing the differences between (or otherwise converging) a predicted output and an actual output. Training continues until the determined error is within a certain threshold (or a threshold number of batches, epochs, or iterations have been reached). Supervised learning is described in more detail with reference to FIG. 4.

FIG. 4 is a flow diagram of an example method for fine-tuning a pretrained machine leaning model using supervised learning, in accordance with some embodiments of the present disclosure.

The pretrained machine learning model 408 is a machine learning model that is trained on domain-neutral data to perform one or more domain-neutral tasks. The pretrained machine learning model 408 can be pretrained using any training method such as supervised learning, unsupervised learning, semi-supervised learning, reinforcement learning, etc. In some embodiments, the pretrained machine learning model 408 can be a neural network model such as neural network 320 of FIG. 3. As described with reference to FIG. 3, the weights 310-313 of the neural network model 320 are updated each training iteration. At the completion of training, the neural network model 320 includes a set of pretrained weights in a pretrained weight matrix trained to perform one or more domain-neutral tasks using domain-neutral data.

The fine-tuning manager 430 fine-tunes an adaptation component 420 using domain-specific data causing a fine-tuned machine learning model 425 to learn how to perform one or more domain-specific tasks. While one adaptation component 420 is shown, one or more adaptation components can be appended to any weight matrix in the pretrained machine learning model 408 (e.g., a weight matrix for encoder layers in the pretrained machine learning model 408, a weight matrix for decoder layers in the pretrained machine learning model 408, a weight matrix for multi-headed attention layers in the pretrained machine learning model 408, etc.). The fine-tuned (or trained) adaptation component 420 together with the pretrained machine learning model 408 results in the fine-tuned machine learning model 425. As described herein, fine-tuning the pretrained machine learning model 408 is fine-tuning (or training) the adaptation component 420 while freezing the domain-neutral pretrained weights of the pretrained weight matrix.

As described herein, supervised learning is a method of training a machine learning model given input-output pairs. An input-output pair (e.g., training input 402 and corresponding pseudo label 418, determined by the training data generator 256 described in FIG. 2) is an input with an associated output. The fine-tuning manager 430 fine-tunes the adaptation component 420 using input-output pairs. In some implementations, the input-output pair can be the manual input-output pairs (e.g., manual input-output pair 104 described in FIG. 1)

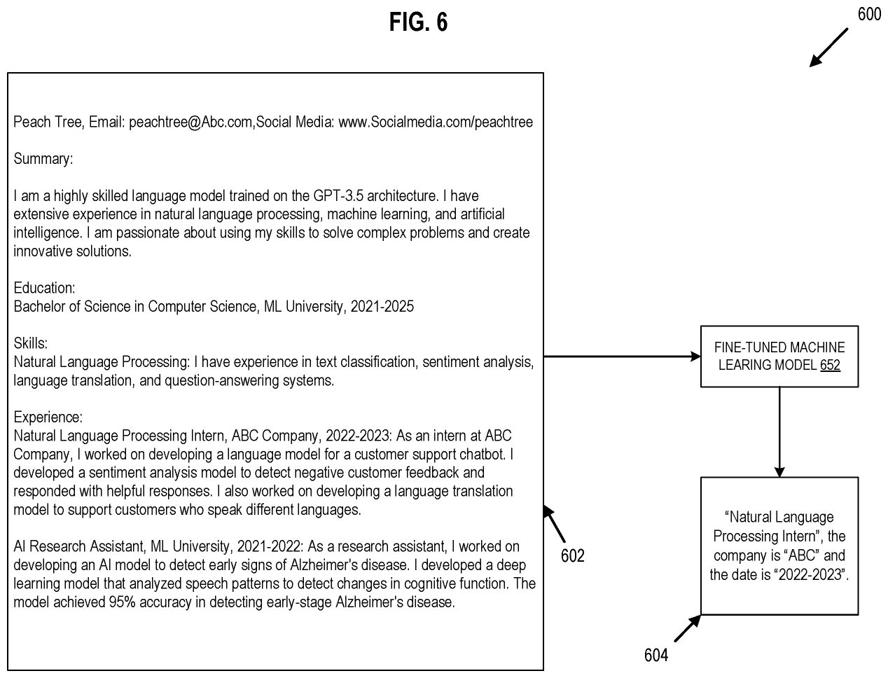

The fine-tuning manager 430 can be used to fine-tune the adaptation component 420 to perform various domain-specific tasks. For example, the adaptation component 420 can be trained to extract content types from digital content. Content types can include extracting particular types of content from a document such as most recent work experience (e.g., a first content type), skills (e.g., a second content type), job titles (e.g., a third content type), contact information (e.g., a fourth content type), educational achievements (e.g., a fifth content type), areas of interest described in a post (e.g., a sixth content type), and qualifications of a job (e.g., a seventh content type). Extracting content, for the purposes of the present disclosure, describes generating text based on text in a document. In other words, extracting content, for the purposes of the present disclosures, is not merely string matching. An example of the fine-tuned model 425 extracting content types is illustrated in FIG. 6. Each of the context type extraction tasks learned by the fine-tuned model 425 can be treated as a sequence prediction objective. As a result, in some embodiments, the same loss function is used to train each of the context type extraction tasks of the sequence prediction objective.

The technologies described herein describe fine-tuning a pretrained machine learning model 408 to perform context extraction tasks associated with a sequence prediction objective. However, other tasks associated with other objectives may be learned using domain-specific training data. For example, the pretrained machine learning model 408 can be fine-tuned to learn how to substitute domain-specific language. For example, the fine-tuned model 425 can receive digital content and subsequently determine semantically related information. Additionally, the fine-tuned model 425 can be fine-tuned to translate domain-specific language from a first language to a second language. Additionally, the fine-tuned model 425 can be fine-tuned to classify content. Additionally, the fine-tuned model 425 can summarize the information in the digital content by paraphrasing the digital content, and in some cases, using semantically related words. In other words, the pretrained machine learning model 408 can be fine-tuned using the fine-tuning manager 430 to optimize a sequence prediction objective (associated with performing content extraction tasks) or optimize a similarity search objective (associated with identifying similar embeddings in an embedding space).

In a non-limiting example, the fine-tuned machine learning model 425 (obtained after fine-tuning the adaptation component 420 using the fine-tuning manager 430) can use embedding based retrieval methods to determine semantically related words, characters, phrases, sentences, and paragraphs, among others. For case of description, word embeddings will be described. However, the fine-tuned machine 425 learning model can also learn embeddings of characters, phrases, sentences, paragraphs, and documents. For example, the fine-tuned machine learning model 425 can learn to encode domain-specific words into an embedding.

An embedding is a latent space representation of the word. The embedding encodes the meaning of the word in an embedding space, where words with similar meanings are positioned closer together in the embedding space. During fine-tuning, the pretrained machine learning model 408 (or the adaptation component 420) learns related words based on past appearances of domain-specific words during training. For example, words such as “phone number” and “contact information” may appear close together in a sentence of a content item received as training input 402. Accordingly, because the likelihood of such words appearing together is high (e.g., such words often appear close together in a sentence), the words will be treated as having a similar semantic value. The fine-tuned machine learning model 425 contextualizes domain-specific language such that when the fine-tuned machine learning model 425 is deployed, the fine-tuned machine learning model 425 can compare words in an input (e.g., a content item) to previously learned words during training. In some embodiments, the cosine similarity of embeddings in the embedding space is used to evaluate the similarity between learned words and words in the input. Words that have a small angle (close to zero degrees) represent semantically related words, while words that have an angle close to ninety degrees represent no semantic similarity.

In some embodiments, a series of fine-tuned machine learning models can be deployed together. For example, a first fine-tuned machine learning model is trained by the fine-tuning manager 430 to perform content extraction tasks to extract content types in a content item (e.g., skills, contact information, most recent job experience, etc.). Subsequently, the extracted content output from the first fine-tuned machine learning model is provided to a second fine-tuned machine learning model trained by the fine-tuning manager 430 to perform a summarization task to identify semantically content associated with the extracted content.

In some embodiments, the fine-tuning manager 430 fine-tunes the weights in the pretrained machine learning model 408. For example, the value of the pretrained weights in the pretrained weight matrix is adjusted according to an error (e.g., the error 412 determined by the comparator 410 comparing the pseudo label 418 to the predicted output 406). In other embodiments, the pretrained weight matrix of the pretrained machine learning model 408 is frozen and the adaptation component 420 including two low-rank weight matrices is trained. In these embodiments, instead of modifying the set of pretrained weights of the weight matrix based on the error, the low-rank set of weights of the domain-specific adaptation component 420 is modified.

As described herein, the pretrained weights trained using the domain-neutral data has a low intrinsic dimension, meaning that the pretrained weights can be represented by fewer weights and still perform the one or more domain-neutral tasks with satisfactory accuracy. In operation, the pretrained weights are decomposed into a set of low-rank matrices (e.g., a first low-rank weight matrix and a second low-rank weight matrix) that represent the interconnections between the non-redundant neurons. The set of low-rank matrices are stored in the adaptation component 420.

A training input 402 is provided to the pretrained machine learning model 408. As described herein, the training input 402 can be a content item (or a portion of a content item such as a sentence or a paragraph). The pretrained machine learning model 408 and the adaptation component 420 then predict output 406 by applying, to the training input 402, both the pretrained weights and the set of low-rank matrices to interconnected nodes in one or more stacks of layers (where a single stack of layers is illustrated in FIG. 3) of the pretrained machine learning model 408.

The error (represented by error signal 412) is determined by comparing the predicted output 406 (e.g., generated text of a content type) to the pseudo label 418 (e.g., a content type determined by the training data generator 256) using the comparator 410.

When fine-tuning the pretrained machine learning model 408 using the adaptation component 420, during each training iteration (or fine-tuning iteration), the set of low-rank matrices of the adaptation component 420 are updated based on the error signal 412 determined from the predicted output 406 and the pseudo label 418. As mathematically described using Equation (3) below, the weights of the fine-tuned machine learning model 425 w_{FINE-TUNE} is determined using the set of frozen weights w (e.g., the pretrained weights in the pretrained weight matrix of the pretrained machine learning model 408), and the domain-specific low-rank weights Δw (e.g., matrices w_{A} and w_{B}) of the adaptation component 420.

$${w}_{FINE - TUNE} = w + Δ w where : Δ w = {w}_{A} + {w}_{B} \qquad ( 3 )$$

In some embodiments, the domain-specific low-rank weights Δw are randomly initialized. In other embodiments, the domain-specific low-rank weights are duplicated weights from the pretrained weight matrix of the pretrained machine learning model 408. As shown in Equation (3) above, Δw includes a first low rank matrix w_{A} and second low rank matrix w_{B}. Mathematically, the relationship of the decomposed matrices w_{A} and w_{B} with respect to the pretrained weights in the pretrained weight matrix is described according to Equations (4) below:

$$w ∈ {ℝ}^{d \times k} , {w}_{A} ∈ {ℝ}^{d \times r} , {w}_{B} ∈ {ℝ}^{r \times k} \qquad ( 4 )$$

Matrices w_{A} and w_{B} can be decomposed from the pretrained weight matrix of the pretrained machine learning model into rank r using any matrix decomposition method such as Lower Upper (LU) matrix decomposition, principal component analysis (PCA), etc. In other words, the rank of matrices w_{A} and w_{B} (e.g., the first low-rank weight matrix and the second low-rank weight matrix) are a result of the factorization of the pretrained weight matrix. The product of the rank of matrices w_{A} and w_{B} return a weight matrix of the dimension of the pretrained weight matrix. The rank represents the latent dimension of the low-rank weights learning the domain-specific task. In some embodiments, the rank r of matrices w_{A} and w_{B} is a tunable hyperparameter. Fine-tuning the weights w_{A} and w_{B} using domain-specific data (e.g., training input 402 and pseudo label 418) defines the first low rank matrix w_{A} and second low rank matrix w_{B} such that the fine-tuned machine learning model 425 can perform a domain-specific task.

In some embodiments, the pretrained machine learning model 408 (and subsequently the fine-tuned machine learning model 425) is a multi-headed machine learning model. A multi-headed machine learning model is a single machine learning model that is trained to perform multiple tasks. Each head of the multi-headed machine learning model includes a stack of layers that perform a task associated with that head. In some embodiments, each head utilizes a unique loss function to train the particular head to perform a task. For example, the pretrained machine learning model 408 can be a pretrained multi-headed machine learning model with two heads. A first head of the pretrained multi-headed machine learning model performs a first domain-neutral task and a second head of the pretrained multi-headed machine learning model performs a second domain-neutral task.

If the pretrained machine learning model 408 is a pretrained multi-headed machine learning model, the fine-tuning manager 430 can train an adaptation component 420 for each head of the pretrained multi-headed machine learning model. As a result, the multi-headed fine-tuned machine learning model can perform multiple domain-specific tasks using the pretrained heads of the pretrained multi-headed machine learning model 408 and an adaptation component 420 for each head. The low-rank of matrices w_{A} and w_{B} of each adaptation component 420 are different for each head of the pretrained multi-headed machine learning model 408.

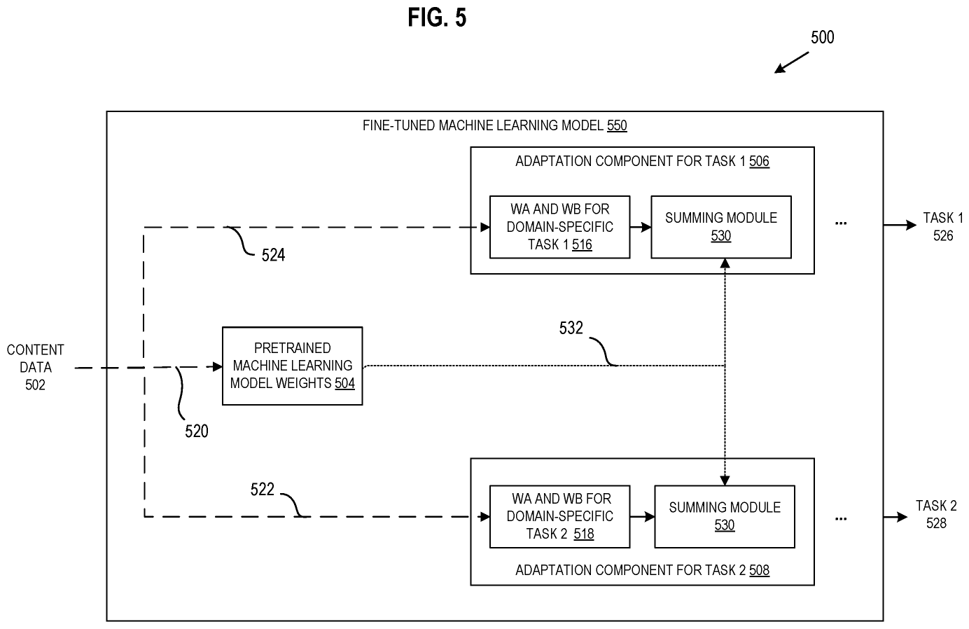

In some embodiments, the fine-tuning manager 430 fine-tunes multiple adaptation components using a single pretrained machine learning model 408. For example, during a first training period the fine-tuning manager 430 fine-tunes a first adaptation component 420 using the pretrained machine learning model 408 to extract a first content type. During a second training period the fine-tuning manager 408 fine-tunes a second adaptation component 420 using the pretrained machine learning model 408 to extract a second content type. In these embodiments, the fine-tuned machine learning model 425 includes two adaptation components 420 and a single pretrained machine learning model 408. FIG. 5 described herein illustrates an example of the fine-tuned machine learning model 550 including two adaptation components fine-tuned to perform two domain-specific tasks.

In addition to fine-tuning the adaptation component 420 to obtain the fine-tuned machine learning model 425, in some embodiments, the fine-tuning manager 430 can fine-tune the pretrained machine learning model 408 using prompt engineering. For example, if the pretrained machine learning model 408 (and subsequently the fine-tuned machine learning model 425) is an LLM, the fine-tuning manager 430 can train the fine-tuned machine learning model 425 to perform domain-specific tasks using soft prompt tuning.

As described herein, LLM models receive a prompt including an instruction of a task to be performed by the LLM. The LLM tokenizes the prompt by partitioning the prompt into one or more characters, words, phrases, or sentences. The token is transformed into an encoded representation (e.g., an embedding, which is a vector representation of the token, capturing the meaning of the token). The embedding is passed through various layers of the LLM (e.g., encoder layers, decoder layers, attention layers) such that the output of the LLM is a predicted category associated with the token (e.g., the token is tagged), a predicted next token associated with the token, or a paraphrase (or summarization) of the token. When an LLM is trained using soft prompt tuning, an extra one or more tokens (soft prompt tokens) are injected as embeddings into one or more layers of the LLM. The soft prompt tokens may be randomly initialized tokens, sampled tokens from most recent token embeddings, or sampled tokens from class labels. The number of soft prompt tokens and the initialization of the soft prompt tokens can be tunable hyperparameters. Fine-tuning the pretrained machine learning model 408 using soft prompts injects domain-specific data into the prompts of the pretrained machine learning model 408, fine-tuning the pretrained machine learning model 408 to obtain the fine-tuned machine learning model 425.

Additionally, or alternatively, the fine-tuning manager 430 can fine-tune the pretrained machine learning model 408 using extra prompts. For example, any one or more prompt engineering methods can be used to determine an explicit prompt containing particular verbiage to help fine-tune the pretrained machine learning model 408 to better perform domain-specific tasks. It may be particularly useful to provide extra prompts to the pretrained machine learning model 408 during training when there is a reduced availability of domain-specific training data (e.g., input-output pairs such as training input 402 and pseudo label 418). Additionally, the extra prompts may increase the speed of learning of the fine-tuned model 425. That is, the rate of converging the predicted output 406 to the pseudo label 418 increases.

In some embodiments, the fine-tuning manager 430 can fine-tune the pretrained machine learning model 408 using negative samples. In some embodiments, negative training samples are obtained by the training data generator 156. For example, negative samples may be part of the input-output training pairs that are provided to fine-tune the pretrained machine learning model 408. Fine-tuning the pretrained machine learning model 408 using negative samples allows the fine-tuned machine learning model 425 to identify when there is not a concept to be extracted from a sample. For example, given the phrase “today is a sunny day,” and the task to extract a skill, the fine-tuned machine learning model 425 would return “None” because there is no skill to be extracted from the phrase “today is a sunny day.”

FIG. 5 is a flow diagram of an example method of deploying multiple adaptation components in a fine-tuned machine learning model, in accordance with some embodiments of the present disclosure.

As described herein, each of the adaptation components include defined low-rank weight matrices that allow the adaptation component to perform a domain-specific task. Using multiple adaptation components allows the fine-tined machine learning model 550 to perform multiple domain-specific tasks including extracting a different content type (e.g., most recent job experience, skills, contact information), substituting characters (or words or phrases or sentences) in digital content, and summarizing digital content.

In the example 500, content data 502 is provided to the fine-tuned machine learning model 550. As shown by dashed lines 520-524, the content data 502 can be synchronously provided to the pre-trained machine learning model weights 504 and each of the sets of domain-specific weights 516-518 of adaptation components 506-508.

As described above, the weights of the fine-tuned machine learning model 550 used to perform a task N (e.g., w_{FINE-TUNE TASK N}) is determined using the set of frozen weights w (e.g., the pretrained weights in the pretrained weight matrix of the pretrained machine learning model illustrated as 504), and the low-rank domain-specific weights for task N (e.g., Δw_{task N} where task N in example 500 is domain-specific task N) of the each adaptation component 506 and 508. As described above, this is mathematically represented according to Equation (3), which is reproduced below:

$${w}_{FINE - TUNE TASK N} = w + Δ {w}_{task N} where : Δ {w}_{task 1} = {w}_{A} + {w}_{B} for domain specific task 1 \; 516 \\ Δ {w}_{task 2} = {w}_{A} + {w}_{B} for domain specific task 2 \; 518 \qquad ( 3 )$$

In operation, w_{A} and w_{B} for domain-specific task 1 516 are applied to interconnected nodes in a stack of layers of the pretrained machine learning model, w_{A} and w_{B} for domain-specific task 2 518 are applied to interconnected nodes in the stack of layers of the pretrained machine learning model, and the pretrained machine learning model weights are applied to interconnected nodes in the stack of layers of the pretrained machine learning model. The stack of layers of the pretrained machine learning model receive the content data 502 such that the weights (e.g., the pretrained machine learning model weights 504, w_{A} and w_{B} for domain-specific task 1 516, and w_{A} and w_{B} for domain-specific task 2 518) are applied to the content data 502.

The output 532 of the pretrained machine learning model weights 504 is a matrix of values determined using pretrained machine learning model weights 504 applied to the content data 502. The output of each of the domain-specific sets of weights (e.g., w_{A} and w_{B} for domain-specific task 1 516, and w_{A} and w_{B} for domain-specific task 2 518) is similarly a matrix of values determined using w_{A} and w_{B} for domain-specific task 1 516 and a matrix of values determined using w_{A} and w_{B} for domain-specific task 2 518. The ability of the fine-tuned machine learning model 550 to perform domain-specific tasks is based on the matrices of values determined using each adaptation component (e.g., adaptation component for task 1 506 and adaptation component for task 2 508) and the pretrained machine learning model weights 504.

For example, the summing module 530 of adaptation component for task 1 506 receives a matrix of values determined using w_{A} and w_{B} for domain-specific task 1 516 and output 532 (e.g., the matrix of values determined using pretrained machine learning model weights 504). In an example, the values determined by the summing module 530 represent one or more scores associated with one or more generated texts based on the content data 502 and the domain-specific task (e.g., task 1). The score represents a probabilistic or statistical likelihood of there being a relationship between the generated text, the domain-specific task, and the content data 502. The score is used to perform the domain-specific task such that the output of the fine-tuned machine learning model 550 is the domain-specific task (e.g., task 1 526)

Similarly, the summing module 530 of adaptation component for task 2 508 receives a matrix of values determined using w_{A} and w_{B} for domain-specific task 2 518 and output 532 (e.g., the matrix of values determined using pretrained machine learning model weights 504). The values determined by the summing module 530 represent one or more scores associated with one or more generated texts based on the content data 502 and the domain-specific task (e.g., task 2). The score represents a probabilistic or statistical likelihood of there being a relationship between the generated text, the domain-specific task, and the content data 502. The score is used to perform the domain-specific task such that the output of the fine-tuned machine learning model 550 is the domain-specific task (e.g., task 2 528)

While not shown, the fine-tuned machine learning model 550 can include additional pre-trained machine learning model weights and additional adaptation components. For example, the task 1 output of the adaptation component for task 1 506 may be input into a subsequent layer with different pretrained machine learning model weights and different adaptation components.

In some embodiments, only a particular task (e.g., task 1 526 or task 2 528) is to be performed given an input content data 502. In these embodiments, only performs the adaptation component associated with the particular task to be performed. As described herein, the pre-processing operation 151 may provide information used by the fine-tuned machine learning model 550 to load or otherwise deploy the adaptation component associated with the particular task to be performed. In other embodiments, all tasks are performed by the fine-tuned model. However, some tasks may return null answers (e.g., receiving a “None” response to a task associated with extracting content type 1) or scores below a confidence threshold.

FIG. 6 is a flow diagram of an example method for deploying the fine-tuned machine learning model, in accordance with some embodiments of the present disclosure.

Example 600 of FIG. 6 illustrates an example of a fine-tuned machine learning model 652 extracting content types from digital content 602. As shown, the fine-tuned machine learning model 652 generates text 604 associated with a most recent work experience extracted from a resume (e.g., digital content 602). Instead of indicating that the digital content 602 includes a most recent work experience (e.g., a first content type), by tagging the digital content 602 with a “most recent work experience” label, for instance, the fine-tuned machine learning model 652 contextualizes the digital content 602 by evaluating the content of the digital content 602 with respect to the task to be performed (e.g., extracting the first content type from the digital content 602). For example, the fine-tuned machine learning model 652 receives the digital content 602 and extracts the first content type from the digital content 602 by identifying words in the digital content 602 that are related to the first content type (e.g., a most recent work experience) and generating text associated with the identified words in the digital content 602. For instance, the generated text 604 identifies Natural Language Processing Intern, as the most recent work experience and identifies additional information associated with the most recent work experience (e.g., the company associated with the most recent work experience, ABC Company, and the dates associated with the most recent work experience, 2022-2023. Although the additional information is contained in the digital content 602, the model creates relationships or logical links between the additional content and the first content type extraction task (e.g., the most recent work experience).

In some embodiments, the fine-tuned machine learning model 652 is trained to generate text associated with other content types such as job descriptions, contact information, and completed degrees present in the digital content 602. Extracting content types by generating text associated with the learned content type, as opposed to identifying or labeling the presence of predetermined content types (as may be performed using NER, for instance) in content provides the fine-tuned machine learning model 652 increased flexibility and opportunity to identify explicit content types and implicit content types. An explicit content type, can be, for example, content (e.g., user skills) that are included in a document (e.g., a resume or profile) by a user. For example, a sentence of a resume may state “I am excellent at Python,” and the explicit content is the user skill “Python.” An implicit content type, can be, for example, content (e.g., user skills) that a machine learning model predicts based on the content in the document. For example, a sentence of a resume may state “I train models with high accuracy,” and the implicit content is the user skill “machine learning experience.”

FIG. 7 is a block diagram of a computing system that includes a training manager component, in accordance with some embodiments of the present disclosure.

In the embodiment of FIG. 7, a computing system 700 includes one or more user systems 710, a network 722, an application software system 730, a training manager 750, and a data storage system 740.

A user system 710 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 710 can be connected to network 722 at the same time or at different times. Different user systems 710 can contain similar components as described in connection with the illustrated user system 710. For example, many different end users of computing system 700 can be interacting with many different instances of application software system 730 through their respective user systems 710, at the same time or at different times.

User system 710 includes a user interface 712. User interface 612 is installed on or accessible to user system 710 by network 722. The user interface 712 enables user interaction with digital content hosted by the application software system 730.

The user interface 712 includes, for example, a graphical display screen that includes graphical user interface elements such as at least one input box or other input mechanism and a space on a graphical display into which digital content can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, the graphical display may be defined using a three-dimensional coordinate system.

In some implementations, user interface 712 enables the user to upload, download, receive, send, or share of other types of digital content items, including posts, articles, comments, and shares, to initiate user interface events, and to view or otherwise perceive output such as data and/or digital content produced by application software system H30 and/or content distribution service 738. For example, user interface 712 can include a graphical user interface (GUI), a conversational voice/speech interface, a virtual reality, augmented reality, or mixed reality interface, and/or a haptic interface. User interface 712 includes a mechanism for logging in to application software system 730, clicking or tapping on GUI user input control elements, and interacting with digital content. Examples of user interface 712 include web browsers, command line interfaces, and mobile app front ends. User interface 712 as used herein can include application programming interfaces (APIs).

In the example of FIG. 7, user interface 712 includes a front-end user interface component of application software system 730. For example, user interface 712 can be directly integrated with other components of any user interface of application software system 730. In some implementations, access to content of the application software system 730 is limited to registered users of application software system 730.

Network 722 includes an electronic communications network. Network 722 can be implemented on any medium or mechanism that provides for the exchange of digital data, signals, and/or instructions between the various components of computing system 700. Examples of network 722 include, without limitation, a Local Area Network (LAN), a Wide Area Network (WAN), an Ethernet network or the Internet, or at least one terrestrial, satellite or wireless link, or a combination of any number of different networks and/or communication links.

Application software system 730 includes any type of application software system that provides or enables the creation, upload, and/or distribution of at least one form of digital content, including ranked digital content. Components of application software system 730 can include an entity graph 732 and/or knowledge graph 734, a user connection network 736, a content distribution service 738, a training data generator 766, a fine-tuned machine learning model 742, a search engine 744, and a graph update service 746.

In the example of FIG. H, application software system 730 includes an entity graph 732 and/or a knowledge graph 734. The relationship between objects can be captured using a graph form. For example, an entity graph 732 is a graphical representation of entities such as users, organizations (e.g., companies, schools, institutions), and content items (e.g., user profiles, job postings, announcements, articles, comments, and shares), as nodes of the graph. An entity graph represents relationships, also referred to as mappings or links, between or among entities as edges, or combinations of edges, between the nodes of the graph. In some implementations, mappings between or among different pieces of data are represented by one or more entity graphs (e.g., relationships between different users, between users and content items, or relationships between job postings, skills, and job titles). In some implementations, the edges, mappings, or links of the graph indicate online interactions or activities relating to the entities connected by the edges, mappings, or links. For example, if a user views and accepts a message from another user, an edge may be created connecting the message-receiving user entity with the message-sending user entity in the graph, where the edge may be tagged with a label such as “accepted.”

In some implementations, knowledge graph 734 is a subset or a superset of entity graph 732. For example, in some implementations, knowledge graph 734 includes multiple different entity graphs 732 that are joined by cross-application or cross-domain edges. For instance, knowledge graph 734 can join entity graphs 732 that have been created across multiple different databases or across different software products. In some implementations, the entity nodes of the knowledge graph 734 represent concepts, such as product surfaces, verticals, or application domains. In some implementations, knowledge graph 734 includes a platform that extracts and stores different concepts that can be used to establish links between data across multiple different software applications. In other implementations, the graph update service 746 extracts and stores different concepts that can be used to establish links and/or nodes in the knowledge graph 734 and or entity graph 732. Such concepts can be obtained as text generated by the fine-tuned machine learning model 742 and used to update the knowledge graph 734 (or entity graph 732) using the graph update service 746. Examples of concepts include a most recent work experience (e.g., a first content type), skills (e.g., a second content type), job titles (e.g., a third content type), contact information (e.g., a fourth content type), educational achievements (e.g., a fifth content type), areas of interest described in a post (e.g., a sixth content type), and qualifications of a job (e.g., a seventh content type). The knowledge graph 734 can be used to generate and export content and entity-level embeddings that can be used to discover or infer new interrelationships between entities and/or concepts, which then can be used to identify related entities.

The knowledge graph 734 and/or entity graph 732 include a graph-based representation of data stored in data storage system 740, described herein. As described above, knowledge graph 734 and/or entity graph 732 represent relationships, also referred to as links or mappings, between entities or concepts as edges, or combinations of edges, between the nodes of the graph. In some implementations, mappings between different pieces of data used by application software system 730 or across multiple different application software systems are represented by the knowledge graph 734.

Portions of entity graph 732 and/or knowledge graph 734 can be automatically re-generated or updated from time to time based on changes and updates to the stored data, e.g., updates to entity data and/or activity data. For example, the graph update service 746 can add nodes and/or links to the entity graph 732 and/or knowledge graph 734. In some embodiments, the graph update service 746 receives data from the fine-tuned machine learning model 742 (trained using the fine-tuning manager 758 of the training manager 750). For example, the graph update service 746 receives text of the first content type (e.g., a most recent work experience extracted from a resume). Subsequently, the graph update service 746 updates the entity graph 732 and/or the knowledge graph 734. For example, the text of the first content type is added as a node to the entity graph 732 and edges between the node are added between the first content type and an entity.

Maintaining updated entity graph 732 and/or knowledge graph 734 allows one or more services to compute various types of relationship weights, affinity scores, similarity measurements, and/or statistical correlations between or among entities and/or concepts of the nodes in the entity graph 732 and/or knowledge graph 734. For example, search engine 744 includes a search engine that enables users of application software system 730 to input and execute search queries on user connection network 736, entity graph 732, knowledge graph 734, and/or one or more indexes or data stores that store retrievable items, such as digital items that can be retrieved and included in a list of search results to be displayed to a user.

In the example of FIG. 7, application software system 730 includes a user connection network 736. User connection network 736 includes, for instance, a social network service, professional social network software and/or other social graph-based applications. Application software system 730 can include, for example, online systems that provide social network services, general-purpose search engines, specific-purpose search engines, messaging systems, content distribution platforms, e-commerce software, enterprise software, or any combination of any of the foregoing or other types of software.

In some implementations, a front-end portion of application software system 730 can operate in user system 710, for example as a plugin or widget in a graphical user interface of a web application, mobile software application, or as a web browser executing user interface 712. In an embodiment, a mobile app or a web browser of a user system 710 can transmit a network communication such as an HTTP request over network 722 in response to user input that is received through a user interface provided by the web application, mobile app, or web browser, such as user interface 712. A server running application software system 730 can receive the input from the web application, mobile app, or browser executing user interface 712, perform at least one operation using the input, and return output to the user interface 712 using a network communication such as an HTTP response, which the web application, mobile app, or browser receives and processes at the user system 710.

In the example of FIG. 7, application software system 730 includes a content distribution service 738. The content distribution service 738 can include a data storage service, such as a web server, which stores digital content items, uploaded by users, created by users, and/or searched for by users. Content distribution service 738 includes, for example, a chatbot or chat-style system, a messaging system, such as a peer-to-peer messaging system that enables the creation and exchange of messages among users of application software system 730, or a news feed. Such generated content can be stored in storage system 740 as content items of the content item data store 754.

In some embodiments, content distribution service 738 processes requests from, for example, application software system 730 and distributes digital content to user systems 710 in response to requests. A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, content distribution service 738 is part of application software system 730. In other implementations, content distribution service 738 interfaces with application software system 730, for example, via one or more application programming interfaces (APIs).

In the example of FIG. 7, application software system 730 includes a search engine 744. Search engine 744 is a software system designed to search for and retrieve information by executing queries on data stores, such as databases, connection networks, and/or graphs (such as the entity graph 732 and/or knowledge graph 734 maintained by the graph update service 746 using extracted data from the fine-tuned machine learning model 742). The queries are designed to find information that matches specified criteria, such as keywords and phrases. For example, search engine 744 is used to retrieve data by executing queries on various data stores of data storage system 740 or by traversing up-to-date entity graph 732 and/or knowledge graph 734. As described herein, the graph update service 746 maintains the entity graph 732 and/or knowledge graph 734 using the content extracted from content items determined by the fine-tuned machine leaning model 742.

In the example of FIG. 7, the training manager 750 includes a training component 752 and fine-tuning manager 758 to train machine learning models to perform domain-specific tasks. The training performed by the training manager 750 is performed in a training pipeline that first generates domain-specific training data (e.g., pseudo labels associated with content) and second uses the generated domain-specific training data to fine-tune a domain-neutral pretrained machine learning model.

The training component 752 performs a first stage of the training pipeline. The training component 752 trains the training data generator 766 to generate domain-specific training data using a limited set of domain-specific training data. In operation, the training component 752 generates prompts for the training data generator 766. As described with reference to FIG. 2, the prompt 220 includes multiple (e.g., five) manually labeled input-output pairs and one unlabeled content item (or a portion of a content item such as a phrase, a sentence, or a paragraph). Using the illustrated example of the five manually labeled input-output pairs, the training data generator 766 generates a text label (referred to herein as a pseudo label) associated with the unlabeled content item. In this manner, the training data generator 766 generates training data by generating pseudo labels for unlabeled content items. In some embodiments, the training data generator 766 is any machine learning model such as an LLM.

The fine-tuning manager 758 performs a second stage of the training pipeline. The fine-tuning manager 758 fine-tunes a pretrained machine learning model to become a fine-tuned machine learning model 742 by fine-tuning (or training) an adaptation component. The adaptation component, together with the pretrained machine learning model, results in the fine-tuned machine learning model 742. In some embodiments, the fine-tuned machine leaning model 742 is any machine learning model such as an LLM. The pretrained machine learning model can be any machine learning model pretrained to perform on or more tasks using domain-neutral data.

The fine-tuning manager 758 can be used to fine-tune the adaptation component to perform various domain-specific tasks. For example, the adaptation component can be trained to extract content types from digital content. Content types can include extracting particular types of content from a document such as most recent work experience (e.g., a first content type), skills (e.g., a second content type), job titles (e.g., a third content type), contact information (e.g., a fourth content type), educational achievements (e.g., a fifth content type), areas of interest described in a post (e.g., a sixth content type), and qualifications of a job (e.g., a seventh content type). Extracting content, for the purposes of the present disclosure, describes generating text based on text in a document. In other words, extracting content, for the purposes of the present disclosures, is not merely string matching. In some embodiments, the fine-tuning manager 758 fine-tunes multiple adaptation components to perform multiple domain-specific tasks.

Data storage system 740 includes data stores and/or data services that store digital data received, used, manipulated, and produced by application software system 730 and/or training manager 750, including content items (such as content items 160 described with reference to FIG. 1), machine learning model training data (such as manual input-output pairs 104 and/or input-output pairs 132 with reference to FIG. 1), machine learning model parameters, and machine learning model inputs and outputs, such as machine-generated classifications and machine-generated score data.

In the example of FIG. 7, data storage system 740 includes a content item data store 754 and a training data store 756. Content item data store 754 stores digital content items created by a user, uploaded by a user, and identified as part of a search request determined by the search engine 744. For example, content items can include job postings, comments, resumes, and articles. In some embodiments, content items include unstructured data. Unstructured data includes files stored without metadata or a predetermined format. Training data store 756 stores training data including input-output pairs manually determined by a user, input-output pairs determined by the training data generator 766 (such as pseudo labels and associated training documents or portions of a training document including a sentence, paragraph, or phrase), and input-output pairs determined by the training data generator 766 and verified by a user).

In some embodiments, data storage system 740 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 740 can be configured to store data produced by real-time and/or offline (e.g., batch) data processing. A data store configured for real-time data processing can be referred to as a real-time data store. A data store configured for offline, or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 740 resides on at least one persistent and/or volatile storage device that can reside within the same local network as at least one other device of computing system 700 and/or in a network that is remote relative to at least one other device of computing system 700. Thus, although depicted as being included in computing system 700, portions of data storage system 740 can be part of computing system 700 or accessed by computing system 700 over a network, such as network 722.

While not specifically shown, it should be understood that any of user system 710, application software system 730, training manager 750, and data storage system 740 includes an interface embodied as computer programming code stored in computer memory that when executed causes a computing device to enable bidirectional communication with any other of 710, application software system 730, training manager 750, and data storage system 740 using a communicative coupling mechanism. Examples of communicative coupling mechanisms include network interfaces, inter-process communication (IPC) interfaces and application program interfaces (APIs).

Each of user system 710, application software system 730, training manager 750, and data storage system 740 is implemented using at least one computing device that is communicatively coupled to electronic communications network 722. Any of user system 710, application software system 730, training manager 750, and data storage system 740 can be bidirectionally communicatively coupled by network 722. User system 710 as well as other different user systems (not shown) can be bidirectionally communicatively coupled to application software system 730 and/or training manager 750.

A typical user of user system 710 can be an administrator or end user of application software system 730 or training manager 750 (such as an administrator generating input-output pairs and/or verifying input-output pairs). User system 710 is configured to communicate bidirectionally with any of application software system 730, training manager 750, and data storage system 740 over network 722.

Terms such as component, module, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 710, application software system 730, training manager 750, and data storage system 740 are implemented using computer software, hardware, or software and hardware, and can include combinations of automated functionality, data structures, and digital data, which are represented schematically in the figures. User system 710, application software system 730, training manager 750, and data storage system 740 are shown as separate elements in FIG. 7 for ease of discussion but, except as otherwise described, the illustration is not meant to imply that separation of these elements is required. The illustrated systems, services, and data stores (or their functionality) of each of user system 710, application software system 730, training manager 750, and data storage system 740 can be divided over any number of physical systems, including a single physical computer system, and can communicate with each other in any appropriate manner.

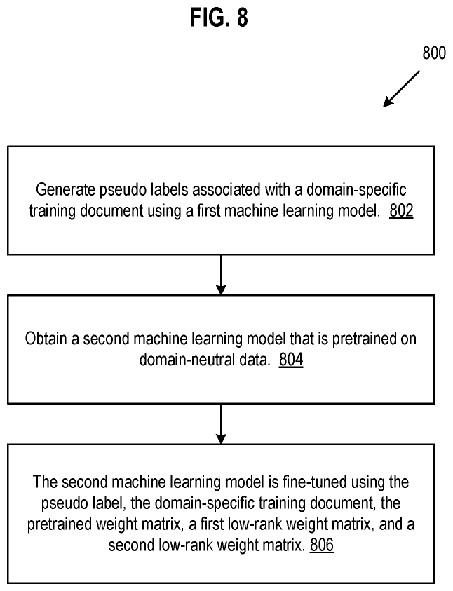

FIG. 8 is a flow diagram of an example method for fine tuning a machine learning model, in accordance with some embodiments of the present disclosure.

The method 800 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 800 is performed by one or more components of the training manager 150 of FIG. 1 or the training manager 750 of FIG. 7. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 802, a processing device generates pseudo labels associated with a domain-specific training document using a first machine learning model. The first machine learning model can be an LLM. The first machine learning model is trained to generate pseudo labels, using semi-supervised learning, by receiving a phrase-level few-shot prompt. The pseudo label includes a machine-generated text of a content type extracted from the domain-specific training document. Unlike systems that use LLMs to tag tokens of text and classify tokens as belonging to a predetermined category (e.g., NER tasks), some embodiments of the first machine learning model generate text as the pseudo label to label unlabeled content items. In this manner, domain-specific training data is generated using a limited set of domain-specific manually labeled training data.

At operation 804, the second machine learning model is fine-tuned using the pseudo label, the domain-specific training document, the pretrained weight matrix, a first low-rank weight matrix, and a second low-rank weight matrix. The second machine learning model is fine-tuned using an adaptation component trained on domain-specific data to perform domain-specific tasks. The adaptation component includes the first low-rank weight matrix and the second low-rank weight matrix. For example, the adaptation component can be trained to extract content types from digital content, substitute domain-specific language in a document, translate domain-specific language from a first language to a second language, classify content, and summarize information by paraphrasing domain-specific language. The pretrained weights in the pretrained weight matrix are frozen during each of the training iterations.

The fine-tuned second machine learning model generates text of the content type from a domain-specific document. Unlike systems that use LLMs to tag tokens of text and classify tokens as belonging to a predetermined category (e.g., NER tasks), some embodiments of the fine-tuned second machine learning model generate text of content types associated with the domain-specific document.

In some implementations, the first machine learning model generates a first training data set of a first size. The first training data set includes a plurality of pseudo labels paired with domain-specific documents. In this manner, the first machine learning model generates domain-specific training data by supplementing any manually determined domain-specific training data with pseudo labels paired with domain-specific documents (or portions of domain-specific documents). The second machine learning model is fine-tuned using the first training data set of the first size. The second machine learning model is pretrained on a second training data set of a second size. The first size of the training data set that is used to fine-tune the second machine learning model is less than the second size of the second training data set used to pretrain the second machine learning model.

In some implementations, the second machine learning model is pretrained on domain-neutral data. The second machine learning model can be pretrained using any training method to perform any one or more tasks. As a result, the second machine learning model includes pretrained weights in a pretrained weight matrix. The second machine learning model can be an LLM.

In some implementations, the fine-tuned second machine learning model receives a document (e.g., a domain-specific document). The fine-tuned second machine learning model subsequently outputs text generated using the document, where the text is of the content type. For example, the fine-tuned second machine learning model trained to extract most recent job experience from a resume will, given a resume, extract (or generate text using the resume) based on the most recent job experience described in the resume.

In some implementations, the first machine learning model includes a large language model, and the second machine learning model includes a large language model.

In some implementations, the domain-specific training document is an unstructured document. An unstructured document includes data stored without metadata or a predetermined format. For example, unstructured data may include data in any format and/or data in a predetermined structure, in contrast to structured data that is formatted according to a predetermined format. Examples of unstructured data include text documents, audio files, video files, analog sensor data, images, and/or other unstructured text files in which the data contained within each file lacks a predefined structure. For example, content of a resume content item 160 can be structured (e.g., using bullet points, headers, spacing, etc.). In contrast, content of comment content item 160 can be less structured (e.g., free style).

In some implementations, the fine-tuning the second machine learning model includes defining the first low-rank weight matrix and the second low-rank weight matrix. Defining the first and second low-rank weight matrices includes converging the error between a predicted output and a known output (e.g., a pseudo label) over a number of training iterations such that defined the first low-rank weight matrix and the second low-rank weight matrix capture unobservable features and relationships of an input training sample. At the completion of training (e.g., when the first and second low-rank matrices are defined), the first and second low-rank matrices are stored. The defined first and second low-rank matrices can be deployed in an adaptation component to fine-tune a pretrained machine learning model.

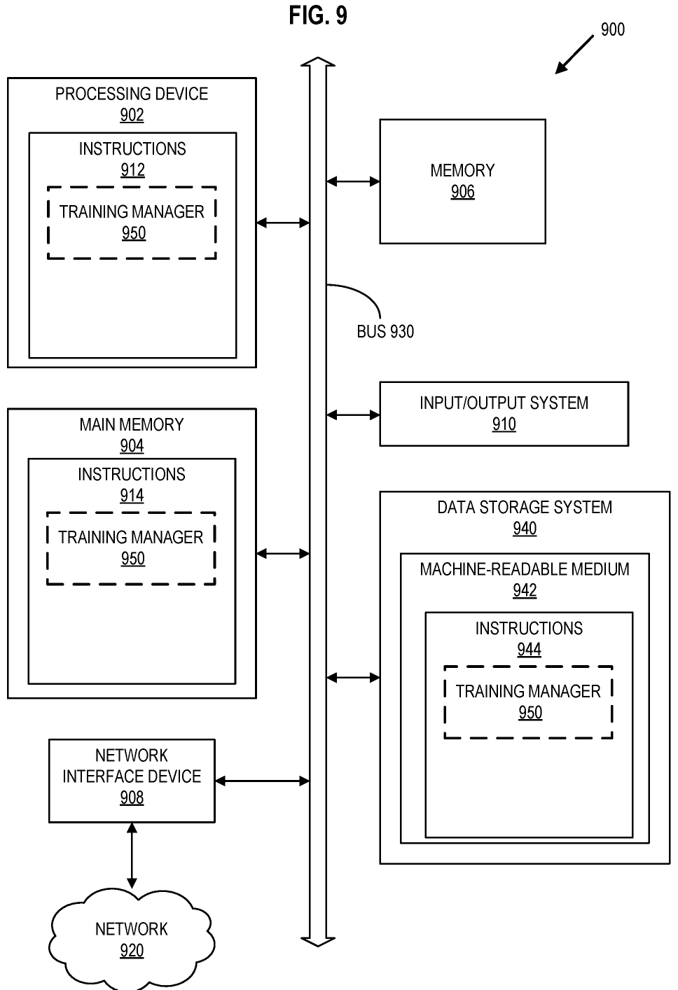

FIG. 9 is a block diagram of an example computer system including a training manager component, in accordance with some embodiments of the present disclosure.

In FIG. 9, an example machine of a computer system 900 is shown, within which a set of instructions for causing the machine to perform any of the methodologies discussed herein can be executed. In some embodiments, the computer system 900 can correspond to a component of a networked computer system (e.g., as a component of the application software system 130 of FIG. 1 or the computer system 700 of FIG. 7) that includes, is coupled to, or utilizes a machine to execute an operating system to perform operations corresponding to one or more components of the training manager 150 of FIG. 1, or the training manager 750 of FIG. 7. For example, computer system 900 corresponds to a portion of computing system 700 when the computing system is executing a portion of the training manager 750 of FIG. 7.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a memory 903 (e.g., flash memory, static random access memory (SRAM), etc.), an input/output system 910, and a data storage system 940, which communicate with each other via a bus 930.

Processing device 902 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be at least one special-purpose processing device such as an application specific integrated circuit (ASIC), a field programmable gate array (FPGA), a digital signal processor (DSP), network processor, or the like. The processing device 902 is configured to execute instructions 912 for performing the operations and steps discussed herein.

In some embodiments of FIG. 9, training manager 950 represents portions of training manager 950 when the computer system 900 is executing those portions of training manager 950. Instructions 912 include portions of training manager 950 when those portions of the training manager 950 are being executed by processing device 902. Thus, the training manager 950 is shown in dashed lines as part of instructions 912 to illustrate that, at times, portions of the training manager 950 are executed by processing device 902. For example, when at least some portion of the training manager 950 is embodied in instructions to cause processing device 902 to perform the method(s) described herein, some of those instructions can be read into processing device 902 (e.g., into an internal cache or other memory) from main memory 904 and/or data storage system 940. However, it is not required that all of the training manager 950 be included in instructions 912 at the same time and portions of the training manager 950 are stored in at least one other component of computer system 900 at other times, e.g., when at least one portion of the training manager 950 is not being executed by processing device 902.

The computer system 900 further includes a network interface device 908 to communicate over the network 920. Network interface device 908 provides a two-way data communication coupling to a network. For example, network interface device 908 can be an integrated-services digital network (ISDN) card, cable modem, satellite modem, or a modem to provide a data communication connection to a corresponding type of telephone line. As another example, network interface device 908 can be a local area network (LAN) card to provide a data communication connection to a compatible LAN. Wireless links can also be implemented. In any such implementation network interface device 908 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 900.

Computer system 900 can send messages and receive data, including program code, through the network(s) and network interface device 908. In the Internet example, a server can transmit a requested code for an application program through the Internet and network interface device 908. The received code can be executed by processing device 902 as it is received, and/or stored in data storage system 940, or other non-volatile storage for later execution.

The input/output system 910 includes an output device, such as a display, for example a liquid crystal display (LCD) or a touchscreen display, for displaying information to a computer user, or a speaker, a haptic device, or another form of output device. The input/output system 910 can include an input device, for example, alphanumeric keys and other keys configured for communicating information and command selections to processing device 902. An input device can, alternatively or in addition, include a cursor control, such as a mouse, a trackball, or cursor direction keys for communicating direction information and command selections to processing device 902 and for controlling cursor movement on a display. An input device can, alternatively or in addition, include a microphone, a sensor, or an array of sensors, for communicating sensed information to processing device 902. Sensed information can include voice commands, audio signals, geographic location information, haptic information, and/or digital imagery, for example.

The data storage system 940 includes a machine-readable storage medium 942 (also known as a computer-readable medium) on which is stored at least one set of instructions 944 or software embodying any of the methodologies or functions described herein. The instructions 944 can also reside, completely or at least partially, within the main memory 904 and/or within the processing device 902 during execution thereof by the computer system 900, the main memory 904 and the processing device 902 also constituting machine-readable storage media. In one embodiment, the instructions 944 include instructions to implement functionality corresponding to training manager 950 (e.g., the training manager 150 of FIG. 1 or the training manager 750 of FIG. H).

Dashed lines are used in FIG. 9 to indicate that it is not required that the training manager 950 be embodied entirely in instructions 912, 914, and 944 at the same time. In one example, portions of the training manager 950 are embodied in instructions 914, which are read into main memory 904 as instructions 914, and portions of instructions 912 are read into processing device 902 as instructions 912 for execution. In another example, some portions of the training manager 950 are embodied in instructions 944 while other portions are embodied in instructions 914 and still other portions are embodied in instructions 912.

While the machine-readable storage medium 942 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 9 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 700, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
using a first machine learning model, generating a pseudo label associated with domain-specific training data, wherein the pseudo label comprises a machine-generated text of a content type extracted from the domain-specific training data; and
fine-tuning a second machine learning model using the pseudo label, the domain-specific training data, a first low-rank weight matrix, and a second low-rank weight matrix, wherein the fine-tuned second machine learning model generates text of the content type from a domain-specific data.

2. The method of claim 1, further comprising:
generating, by the first machine learning model, a first training data set of a first size, wherein the first training data set comprises a plurality of pseudo labels paired with domain-specific documents; and
fine-tuning the second machine learning model using the first training data set of the first size.

3. The method of claim 2, wherein the second machine learning model is pretrained on a second training data set of a second size, and the first size of the first training data set is less than the second size of the second training data set.

4. The method of claim 1, further comprising:
accessing the second machine learning model pretrained on domain-neutral data, wherein the second machine learning model comprises a plurality of pretrained weights in a pretrained weight matrix.

5. The method of claim 1, wherein the first machine learning model comprises a large language model and wherein the second machine learning model comprises a large language model.

6. The method of claim 1, wherein the domain-specific training document is an unstructured document.

7. The method of claim 1, wherein fine-tuning the second machine learning model comprises defining the first low-rank weight matrix and the second low-rank weight matrix, and the method further comprises:
storing the defined first low-rank weight matrix and the defined second low-rank weight matrix.

8. The method of claim 7, further comprising:
inputting, to the second machine learning model comprising a plurality of pretrained weights in a pretrained weight matrix, a document to obtain text of the content type from the document, wherein the second machine learning model further comprises an adaptation component comprising the defined first low-rank weight matrix and the defined second low-rank weight matrix.

9. A system comprising:
at least one processor; and
at least one memory device coupled to the at least one processor, wherein the at least one memory device comprises instructions that, when executed by the at least one processor, cause the at least one processor to perform at least one operation comprising:
using a first machine learning model, generating a pseudo label associated with domain-specific training data, wherein the pseudo label comprises a machine-generated text of a content type extracted from the domain-specific training data;
fine-tuning a second machine learning model using the pseudo label, the domain-specific training data, a first low-rank weight matrix, and a second low-rank weight matrix; wherein the fine-tuned second machine learning model generates text of the content type from a domain-specific data.

10. The system of claim 9, wherein the instructions, when executed by the at least one processor, cause the at least one processor to perform at least one operation further comprising:
generating, by the first machine learning model, a first training data set of a first size, wherein the first training data set comprises a plurality of pseudo labels paired with domain-specific documents; and
fine-tuning the second machine learning model using the first training data set of the first size.

11. The system of claim 10, wherein the second machine learning model is pretrained on a second training data set of a second size, and the first size of the first training data set is less than the second size of the second training data set.

12. The system of claim 9, wherein the first machine learning model comprises a large language model and wherein the second machine learning model is a large language model.

13. The system of claim 9, wherein the domain-specific data is an unstructured document.

14. The system of claim 9, wherein fine-tuning the second machine learning model comprises defining the first low-rank weight matrix and the second low-rank weight matrix, and the instructions, when executed by the at least one processor, cause the at least one processor to perform at least one operation further comprising:
storing the defined first low-rank weight matrix and the defined second low-rank weight matrix.

15. The system of claim 14, wherein the instructions, when executed by the at least one processor, cause the at least one processor to perform at least one operation further comprising:
inputting, to the second machine learning model comprising a plurality of pretrained weights in a pretrained weight matrix, a document to obtain text of the content type from the document, wherein the second machine learning model further comprises an adaptation component comprising the defined first low-rank weight matrix and the defined second low-rank weight matrix.

16. A non-transitory machine-readable storage medium comprising instructions that, when executed by at least one processor, cause the at least one processor to perform at least one operation comprising:
using a first machine learning model, generating a pseudo label associated with domain-specific training data, wherein the pseudo label comprises a machine-generated text of a content type extracted from the domain-specific training data;
fine-tuning a second machine learning model using the pseudo label, the domain-specific training data, a first low-rank weight matrix, and a second low-rank weight matrix; wherein the fine-tuned second machine learning model generates text of the content type from a domain-specific data.

17. The non-transitory machine-readable storage medium of claim 16, wherein the instructions, when executed by the at least one processor, cause the at least one processor to perform at least one operation further comprising:
generating, by the first machine learning model, a first training data set of a first size, wherein the first training data set comprises a plurality of pseudo labels paired with domain-specific documents; and
fine-tuning the second machine learning model using the first training data set of the first size.

18. The non-transitory machine-readable storage medium of claim 17, wherein the second machine learning model is pretrained on a second training data set of a second size, and the first size of the first training data set is less than the second size of the second training data set.

19. The non-transitory machine-readable storage medium of claim 16, wherein the instructions, when executed by the at least one processor, cause the at least one processor to perform at least one operation further comprising:
inputting, to the fine-tuned second machine learning model, a document; and
receiving, from the second machine learning model, text generated using the document, wherein the text is of the content type.

20. The non-transitory machine-readable storage medium of claim 16, wherein the first machine learning model comprises a large language model and wherein the second machine learning model is a large language model.
